(19) United States
(12) Patent Application Publication
(10) Pub. No.: US 2009/0274614 A1
(43) Pub. Date: Nov. 5, 2009

(54) HYDROGEN STORAGE MATERIAL AND PREPARATION THEREOF

(76) Inventors: Qing Gong, Shenzhen (CN); Xiaoxia Deng, Shenzhen (CN); Xiaofeng Cheng, Shenzhen (CN); Faliang Zhang, Shenzhen (CN)

Correspondence Address: BRINKS HOFER GILSON & LIONE, P.O. BOX 10395, CHICAGO, IL, 60610, US

(21) Appl. No.: 12/433,227

(22) Filed: Apr. 30, 2009

(30) Foreign Application Priority Data
May 4, 2008 (CN) 200810094115.6

(51) Int. Cl. B01J 20/10; C01B 3/02

(52) U.S. Cl. 423/648.1; 502/407

(57) ABSTRACT

A hydrogen storage material comprises particles of a hydrogen storage alloy dispersed in a matrix. The alloy has a formula of LNi₅₋ₓMₓ. L is at least one element selected from lanthanoids, and M is at least one element selected from Group II, Group III, Group VIIB, and Group VIIIB of the element periodic table. x is in a range of from 0 to about 4.5. A method for preparing the hydrogen storage material comprises: preparing particles of the hydrogen storage alloy; preparing a matrix forming material; mixing the alloy particles and the material; and solidifying the mixture to form a matrix with the particles dispersed therein.

The present application claims priority to Chinese Patent Application No. 200810094115.6, filed May 4, 2008, the entirety of which is hereby incorporated by reference.

### FIELD OF THE DISCLOSURE

The present disclosure relates to a hydrogen storage material and a method of preparing such a material.

### BACKGROUND OF THE DISCLOSURE

A hydrogen storage alloy comprises an element having an affinity with hydrogen, and capable of absorbing and releasing hydrogen in a reversible manner. The existing hydrogen storage alloys mainly include: rare earth series, titanium series, zirconium series, and magnesium series. They are generally in four different forms: AB₅ (e.g., LaNi₅), AB (e.g., FeTi), AB₂ (e.g., ZrV₂), and A₂B (e.g., Mg₂Ni).

In recent years, there are numerous applications of hydrogen storage alloys. For example, they can store or transport hydrogen safely in an ordinary container. Since hydrogen storage alloys allow selective absorption and desorption of hydrogen, they can also be used for purifying hydrogen. Another application is in electrode materials for the nickel-metal hydride batteries, which can replace conventional nickel-cadmium batteries. Those nickel metal-hydride batteries have been utilized as the power sources for a variety of portable electronic equipments, electric vehicles, etc.

The conventional hydrogen storage alloys can have a number of shortcomings in the above-described applications. The alloys may collapse into fine powders in several times to one hundred times of hydrogen absorption and desorption. This pulverization of the alloy may decrease the storage efficiency. At the same time, the fine powders may pass through the filter to cause equipment damage. When these hydrogen storage alloys are used as electrode materials of a battery, the pulverized powders may fall off from the surface of an electrode substrate after many times of charge and discharge processes. Therefore, the discharge capacity of the battery may decrease, and the life of the battery may be impaired. Another problem of the hydrogen storage alloys is that they expand and contract during the absorption and desorption of hydrogen. They may be deformed or cracked by strain energy generated upon expansion and contraction. Furthermore, the hydrogen storage alloys are sensitive to some impurity gases, such as O₂, H₂O, H₂S, SO₂, CO, and so on. The hydrogen storage capacity may decrease in the presence of other gases.

A few approaches have been designed to address these problems. For example, the alloys have been modified by alloying with various other elements to improve their resistance to pulverization during hydrogen absorption-desorption cycles. Generally, hydrogen absorption-desorption kinetics for these alloys is slow due to a low degree of porosity. The strength of the alloys may be decreased with increasing the degree of porosity.

It would be desirable to develop a hydrogen storage material that is resistant to pulverization during hydrogen absorption-desorption processes and has a stable performance in the presence of impurity gases.

### SUMMARY OF THE DISCLOSURE

In one aspect, a hydrogen storage material comprises particles of a hydrogen storage alloy dispersed in a matrix. The alloy has a formula of LNi₅₋ₓMₓ. L is at least one element selected from lanthanoids, and M is at least one element selected from Group II, Group III, Group VIIB, and Group VIIIB of the element periodic table. x is in a range of from 0 to about 4.5.

In another aspect, a hydrogen storage material comprises particles of a hydrogen storage alloy dispersed in SiO₂. The hydrogen storage alloy is selected from a group consisting of LaNi_{4.3}Al_{0.7}, LaNi_{4.5}Mg_{0.5}, LaNi_{4.5}Fe_{0.5}, LaNi_{4.5}Mn_{0.5}, LaNi_{4.5}CO_{0.5}, and combinations thereof.

In yet another aspect, a method for preparing a hydrogen storage material comprises: preparing particles of a hydrogen storage alloy, preparing a matrix forming material; mixing the alloy particles and the material; and solidifying the mixture to form a matrix with the particles dispersed therein. The alloy has a formula of LNi₅₋ₓMₓ. L is at least one element selected from lanthanoids, and M is at least one element selected from Group II, Group III, Group VIIB, and Group VIIIB of the element periodic table. x is in a range of from 0 to about 4.5.

### BRIEF DESCRIPTION OF THE DRAWINGS

FIG. 1 is a photograph of the alloy particles LaNi_{4.3}Al_{0.7} prepared in example 1.

FIG. 2 is a photograph of the composite material LaNi_{4.3}Al_{0.7}/SiO₂ prepared in example 1.

FIG. 3 is a scanning electron microscope (SEM) photograph of the composite material LaNi_{4.3}Al_{0.7}/SiO₂ prepared in example 1.

FIG. 4 is a photograph of the composite material LaNi_{4.3}Al_{0.7}/SiO₂ prepared in example 1 after sixty times of hydrogen absorption and desorption processes.

FIG. 5 is a photograph of the hydrogen storage material prepared in control 1 after sixty times of hydrogen absorption and desorption processes.

FIG. 6 shows the pressure vs. composition isotherms of the alloy particles M1, the hydrogen storage material C1 prepared in example 1, and the hydrogen storage material B1 prepared in control 1 at about 360 K.

FIG. 7 shows the hydrogen absorption kinetic isotherms of the alloy particles M1, the hydrogen storage material C1, and the hydrogen storage material B1. The measurements were performed at about 360 K under H₂ and 50 ppm CO.

### DETAILED DESCRIPTION OF THE PREFERRED EMBODIMENTS

According to one embodiment of the present disclosure, a hydrogen storage material is provided. The material comprises particles of a hydrogen storage alloy dispersed in a matrix. The alloy has a formula of LNi₅₋ₓMₓ. L is at least one element selected from lanthanoids, and M is at least one element selected from Group II, Group III, Group VIIB, and Group VIIIB of the element periodic table. x is in a range of from 0 to about 4.5.

L can be any lanthanoid elements. The preferred example is lanthanum. Preferably, M is selected from a group consisting of Al, Fe, Mg, Mn, Co, and combinations thereof. Preferably, x is in a range of from about 0.1 to about 4. More preferably, the alloy is selected from a group consisting of LaNi_{4.3}Al_{0.7}, LaNi_{4.5}Mg_{0.5}, LaNi_{4.5}Fe_{0.5}, LaNi_{4.5}Mn_{0.5}, LaNi_{4.5}CO_{0.5}, and combinations thereof.

The matrix can be formed from any suitable material. Preferably, it is formed from Sio₂. More preferably, the weight ratio of the alloy and SiO₂ is between about 1:0.2 to about 1:2.5.

According to another embodiment of the present disclosure, a method for preparing a hydrogen storage material is provided. The method comprises the steps of: preparing particles of a hydrogen storage alloy; preparing a matrix forming material; mixing the alloy particles and the material; and solidifying the mixture to form a matrix with the particles dispersed therein. The alloy has a formula of LNi₅₋ₓMₓ. L is at least one element selected from lanthanoids, and M is at least one element selected from Group II, Group III, Group VIIB, and Group VIIIB of the element periodic table. x is in a range of from 0 to about 4.5.

The particles of hydrogen storage alloy can be any suitable commercially available alloy or can be prepared by any suitable method. For example, the alloy particles can be prepared by melting a raw material comprising L, Ni, and M to form an alloy ingot; and crushing the ingot into particles. The melting can be performed in a vacuum induction furnace. The alloy ingot can be further treated to provide a homogenized alloy. For example, the alloy ingot in a sealed vacuum quartz tube can be placed in a heat treatment furnace. The temperature can be about 800 to about 1000° C. and held for about 2 to about 8 hours. Then the alloy ingot is cooled and crushed into millimeter range particles by mechanical pulverization. Then the alloy particles can be further treated by hydrogen absorption and desorption. Hydrogen absorption and desorption are repeated for about 10-30 times. These processes can be performed in a computer-controlled instrument, for example, Sieverts device (Advanced Material Company, GRC controller). The particles can be sieved and collected. Preferably, the sieved particles have an average diameter of from about 5 to about 300 μm.

The matrix forming material can be any suitable material. The matrix forming material can comprise a solvent. The solvent can be any suitable solvent, such as alcohols and water. The solvent can be removed after the alloy particles and the matrix forming material are mixed. The mixture can also stand at about 20 to about 40° C. for a few days before the solvent is removed. Preferably, the mixture is allowed to stand for about 6 to about 15 days. The removing solvent procedure can be any suitable method, such as vacuuming. The vacuuming can be performed under the pressure of about 0.1 to about 1 Pa for about 5 to about 10 hours.

The preferred matrix forming material is tetrapropyl orthosilicate. Preferably, the weight ratio of the hydrogen storage alloy particles and tetrapropyl orthosilicate is between about 1:1 to about 1:10. Preferably, a tetrapropyl orthosilicate solution in propyl alcohol and water is used. The following procedure can be used to form the solution. Propyl alcohol and tetrapropyl orthosilicate are mixed to form a first solution. Preferably, the volume ratio of propyl alcohol and tetrapropyl orthosilicate is between about 1:1.2 to about 1:2.5. Propyl alcohol and water are mixed to form a second solution. Preferably, the volume ratio of propyl alcohol and water is between about 1:0.3 to about 1:0.8. The preferred pH of the second solution is between about 1 to about 3. Any suitable acid can be used to adjust the pH of the solution, such as HCl. Then the second solution can be added into the first solution at a volume ratio of from about 1:1 to about 1:2 to form a third solution. This step can be performed at about 60 to about 90° C. The third solution then is stirred at a stirring speed of from about 50 to about 150 r/min for about 2 to about 8 hours to provide a matrix forming material.

The temperature for mixing the matrix forming material with hydrogen storage alloy particles can be in a range of from about 60 to about 100° C., preferably about 70 to about 90° C.

The description of the present disclosure is further illustrated by the following examples.

### Example 1

A hydrogen storage material and a preparation method of the present disclosure are illustrated in this example.

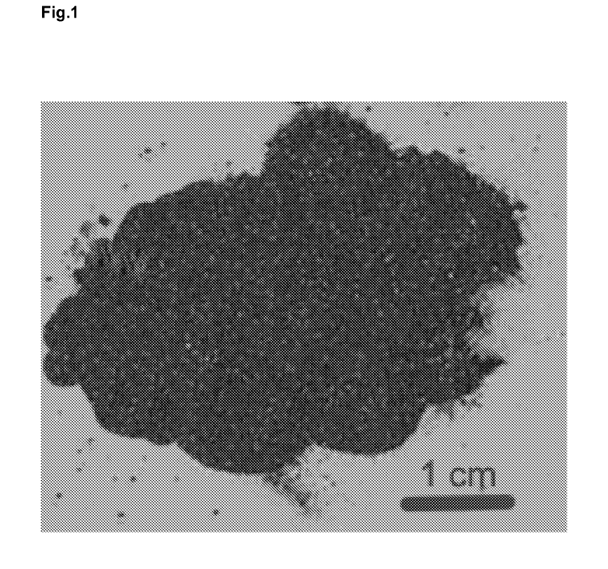

(1) A hydrogen storage alloy ingot LaNi_{4.3}Al_{0.7} was prepared. The purities of La, Ni and Al were 99.5%, 99% and 99%, respectively. The raw material was melted in a vacuum induction furnace to form an alloy ingot. The alloy ingot in a vacuum quartz tube was put into a heat treatment furnace. The temperature was about 1200° C. and held for about 10 hours. After the alloy ingot was cooled, it was pulverized into millimeter range particles by mechanical pulverization. The particles were sieved with a 200 mesh sieve after they underwent 40 times of hydrogen absorption and desorption in a computer-controlled Sieverts device (Advanced Material Company, GRC controller). The sieved fine particles were collected and placed in a sealed container. The prepared alloy particles were marked as sample M1. FIG. 1 is a photograph of the prepared LaNi_{4.3}Al_{0.7} alloy particles. The photograph was taken with a camera SonyT-200.

(2) 40 mL propyl alcohol and 80 mL tetrapropyl orthosilicate were taken respectively using a measuring cylinder and put into a flask. The mixture was stirred with a glass rod in order to mix uniformly. Then the mixed solution was put into a three-neck bottle. The prepared solution was marked as C1A.

90 mL propyl alcohol and 40 mL distilled water were taken respectively using a measuring cylinder and put into a flask. The mixture was stirred with a glass rod in order to mix uniformly. Dilute hydrochloric acid (concentration of 25%) was added into the mixture during stirring. The acidity of the solution was measured with a pH indicator paper. The pH was adjusted to 1. The prepared solution was marked as C1B.

Then, the solution C1B was added dropwise into the solution C1A by a separation funnel. Meanwhile the temperature of the solution was held at about 90° C. in a water bath. The obtained solution was stirred at a low speed (about 110 r/min) with an electromagnetic stirrer for about 5 hours to provide a matrix forming material.

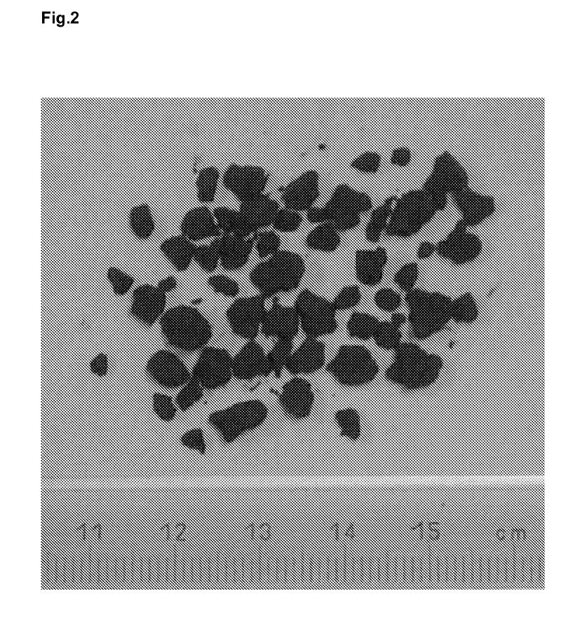

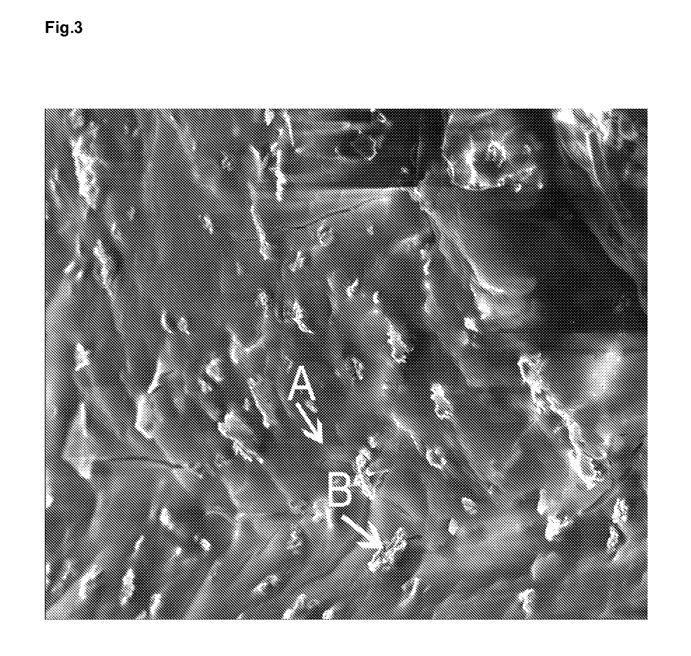

(3) The matrix forming material was transferred from the three-neck bottle to a beaker. Meanwhile the solution was stirred continuously using a mechanical stirrer (the stirring speed was about 100 r/min). 32 g of the alloy particles M1 prepared in step (1) were added and dispersed in the matrix forming material. After the alloy particles were mixed with the matrix forming material uniformly, the beaker was sealed and the mixture was allowed to stand in a thermostatic water bath at about 90° C. for about 3 hours. The mixture was further left standing at room temperature for about 10 days. Then the mixture was vacuumized under the pressure of about 0.5 Pa and held for about 5 hours. After the solvent was removed sufficiently, the hydrogen storage material C1 was provided. FIG. 2 is a photograph of composite material LaNi_{4.3}Al_{0.7}/SiO₂. The photograph was taken with a camera SonyT-200. Cambridge S360 scanning electron microscope was used to obtain a SEM photograph. FIG. 3 is a SEM photograph of composite material LaNi_{4.3}Al_{0.7}/SiO₂. A is SiO₂ matrix, and B is LaNi_{4.3}Al_{0.7} particle. It shows that LaNi_{4.3}Al_{0.7} particles are dispersed in the SiO₂ matrix uniformly and also combine with the matrix well.

### Example 2

A hydrogen storage material and a preparation method of the present disclosure are illustrated in this example.

A hydrogen storage alloy of a formula LaNi_{4.5}Mg_{0.5} was prepared according to the method described in Example 1. The alloy particles was marked as sample M2. The matrix forming material was also prepared according to the method in Example 1.32 g of M2 was added into the SiO₂ a matrix forming material to provide the hydrogen storage material C2.

### Example 3

A hydrogen storage material and a preparation method of the present disclosure are illustrated in this example.

A hydrogen storage alloy of a formula LaNi_{4.5}Fe_{0.5} was prepared according to the method described in Example 1. The matrix forming material was also prepared according to the method in Example 1. 32 g of M3 was added into the matrix forming material to provide the hydrogen storage material C3.

### Example 4

A hydrogen storage material and a preparation method of the present disclosure are illustrated in this example.

A hydrogen storage alloy of a formula LaNi_{4.5}Mn_{0.5} was prepared according to the method described in Example 1. The matrix forming material was also prepared according to the method in Example 1. 32 g of M4 was added into the matrix forming material to provide the hydrogen storage material C4.

### Example 5

A hydrogen storage material and a preparation method of the present disclosure are illustrated in this example.

A hydrogen storage alloy of a formula LaNi_{4.5}CO_{0.5} was prepared according to the method described in Example 1. The matrix forming material was also prepared according to the method in Example 1.32 g of M5 was added into the matrix forming material to provide the hydrogen storage material C5.

### Example 6

A hydrogen storage material and a preparation method of the present disclosure are illustrated in this example.

A hydrogen storage alloy of a formula LaNi_{4.3}Al_{0.7} was prepared according to the method described in Example 1. The difference was that the solution C6A, which was prepared with 50 mL propyl alcohol and 80 mL tetrapropyl orthosilicate, was used in the step (2) to prepare hydrogen storage material C6.

### Example 7

A hydrogen storage material and a preparation method of the present disclosure are illustrated in this example.

A hydrogen storage alloy of a formula LaNi_{4.3}Al_{0.7} was prepared according to the method described in Example 1. The difference was, the solution C7A, which was prepared with 35 mL propyl alcohol and 80 mL tetrapropyl orthosilicate, was used in the step (2) to prepare the hydrogen storage material C7.

Control 1

A hydrogen storage material prepared with a matrix forming material is illustrated in this control. The matrix forming material was prepared with tetraethyl orthosilicate and ethanol.

A hydrogen storage material B1 was prepared according to the method described in Example 1. The alloy had a formula of LaNi_{4.3}Al_{0.7}. The difference was, 50 mL ethanol and 100 mL tetraethyl orthosilicate were used to prepare the solution B1A at about 25° C. in the step (2). The matrix forming material was mixed with the alloy particles at about 25° C. in the step (3).

Control 2

A hydrogen storage material prepared with a matrix forming material is illustrated in this control. The matrix forming material was prepared with tetraethyl orthosilicate and ethanol.

A Hydrogen storage material B2 was prepared according to the method described in Example 2. The alloy had a formula of LaNi_{4.5}Mg_{0.5}. The difference was, 50 mL ethanol and 100 mL tetraethyl orthosilicate were used to prepare the solution B1A at about 25° C. in the step (2). The matrix forming material was mixed with the alloy particles at about 25° C. in the step (3).

Control 3

A hydrogen storage material prepared with a matrix forming material is illustrated in this control. The matrix forming material was prepared with tetraethyl orthosilicate and ethanol.

A hydrogen storage material B3 was prepared according to the method described in Example 3. The alloy had a formula of LaNi_{4.5}Fe_{0.5}. The difference was, 50 mL ethanol and 100 mL tetraethyl orthosilicate were used to prepare the solution B1A at about 25° C. in the step (2). The matrix forming material was mixed with the alloy particles at about 25° C. in the step (3).

### Performance Test

The performances of the hydrogen storage materials prepared in the above examples were tested with a Sieverts device. The tests include pressure-composition isotherms (PCT curves), hydrogen absorption kinetics, and hydrogen absorption and desorption circulation.

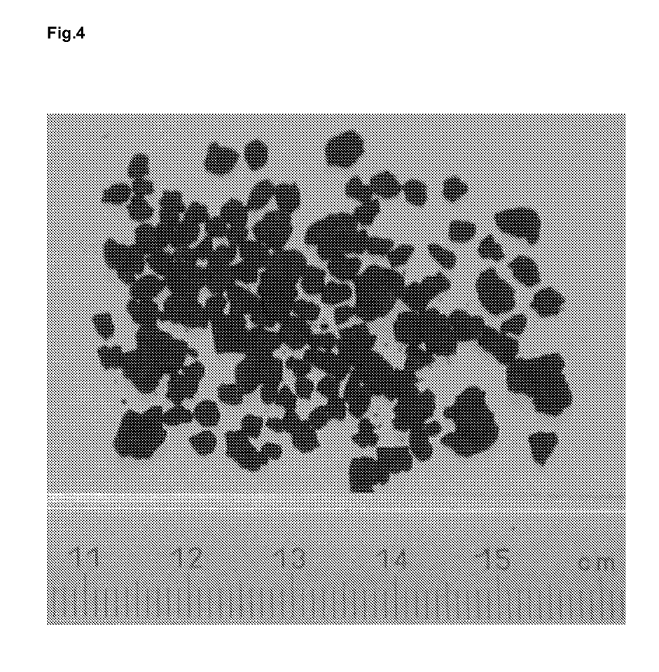

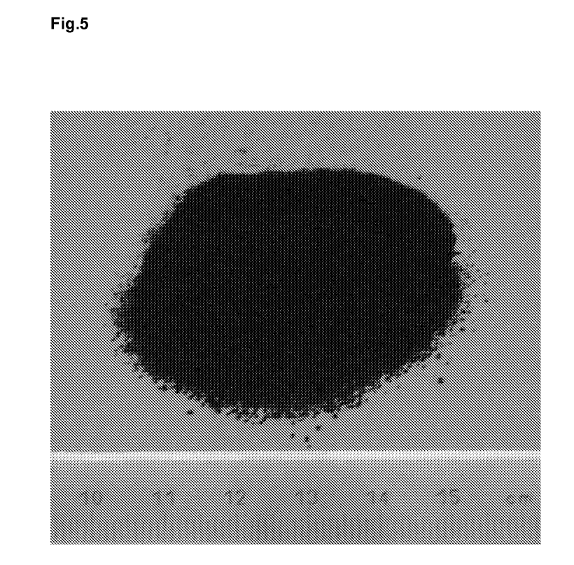

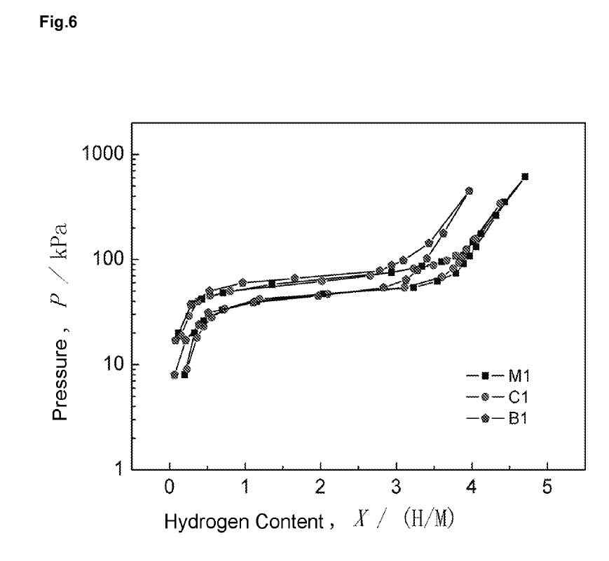

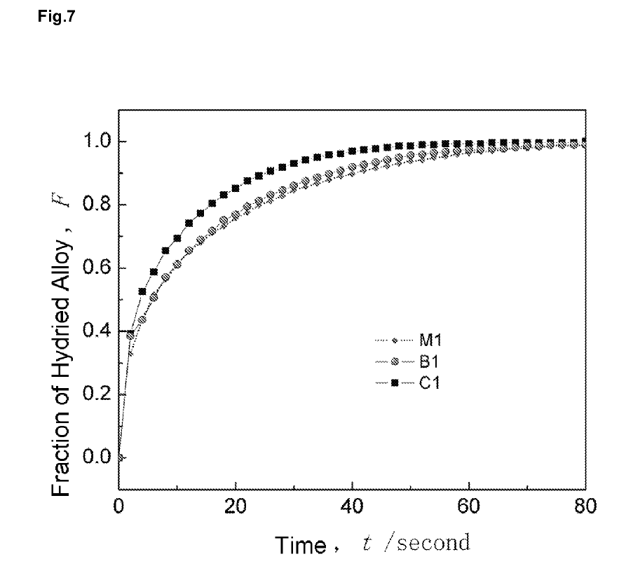

The configuration of the hydrogen storage material C1 after sixty times of hydrogen absorption and desorption is shown in FIG. 4. We can see the material was resistance to pulverization. The configuration of hydrogen storage material B1 after sixty times of hydrogen absorption and desorption is shown in FIG. 5. The hydrogen storage material was crushed into several hundred micrometers size fine powders after sixty times of hydrogen absorption and desorption. The hydrogen absorption and desorption PCT curves of the samples M1, C1 and B1 at about 380 K are shown in FIG. 6. The hydrogen absorption and desorption performance of the sample C1 is better than that of B1. The results of hydrogen absorption kinetics of M1, C1-C7 and B1-B3 are shown in Table 1. T_{0.9} is the required time for the materials reaching 90% of the maximum hydrogen absorption capacity. From Table 1 we can see the hydrogen absorption kinetics of C1-C3 are better than that of M1 and B1-B3, respectively. The hydrogen absorption kinetic isotherms of M1, C1 and B1 at about 360 K in hydrogen atmosphere containing 50 ppm CO are shown in FIG. 7. Sample M1 was obviously poisoned. The hydrogen absorption kinetic isotherm of C1 is almost the same of that in high purity hydrogen atmosphere.

TABLE 1

| | | T_{0.9} (s) | | | |
|---|---|---|---|---|---|
| | | 380 K | | 400 K | |
| | | | Absorption | | Absorption |
| | | | and | | and |
| | | | Desorption | | Desorption |
| Embod- | | | Hydrogen | | Hydrogen |
| iment | Sample | Initial | for 60 | Initial | for 60 |
| Number | Number | Activation | times | Activation | times |
| | M1 | 45.7 | 50.8 | 49.8 | 57.8 |
| Example 1 | C1 | 27.4 | 25.1 | 30.9 | 28.7 |
| Example 2 | C2 | 50.5 | 67.8 | 73.4 | 89.6 |
| Example 3 | C3 | 45.8 | 51.7 | 57.9 | 65.3 |
| Example 4 | C4 | 43.1 | 46.3 | 45.6 | 56.4 |
| Example 5 | C5 | 49.8 | 57.1 | 53.8 | 59.8 |
| Example 6 | C6 | 56.8 | 59.8 | 60.9 | 65.8 |
| Example 7 | C7 | 45.9 | 47.8 | 53.8 | 58.9 |
| Control 1 | B1 | 42.8 | 43.7 | 44.2 | 49.9 |
| Control 2 | B2 | 67.9 | 78.4 | 81.1 | 90.0 |
| Control 3 | B3 | 50.8 | 68.2 | 73.9 | 80.2 |

Many modifications and other embodiments of the present disclosure will come to mind to one skilled in the art to which the present disclosure pertains having the benefit of the teachings presented in the foregoing description. It will be apparent to those skilled in the art that variations and modifications of the present disclosure can be made without departing from the scope or spirit of the present disclosure. Therefore, it is to be understood that the invention is not limited to the specific embodiments disclosed and that modifications and other embodiments are intended to be included within the scope of the appended claims. Although specific terms are employed herein, they are used in a generic and descriptive sense only and not for purposes of limitation.

We claim:

1. A hydrogen storage material comprising:
particles of a hydrogen storage alloy dispersed in a matrix,
wherein the alloy has a formula of LNi₅₋ₓMₓ, wherein L is at least one element selected from lanthanoids, and M is at least one element selected from Group II, Group III, Group VIIB, and Group VIIIB of the element periodic table, and wherein x is in a range of from 0 to about 4.5.

2. The material of claim 1, wherein the matrix comprises SiO₂.

3. The material of claim 1, wherein the alloy particles have a diameter in a range of from about 5 to about 300 micrometers.

4. The material of claim 1, wherein L is lanthanum.

5. The material of claim 1, wherein M is at least one element selected from a group consisting of Al, Fe, Mg, Mn, and Co.

6. The material of claim 1, wherein x is in a range of from about 0.1 to about 4.

7. The material of claim 2, wherein the weight ratio of the alloy to the SiO₂ is from about 1:0.2 to about 1:2.5.

8. A hydrogen storage material comprising:
particles of a hydrogen storage alloy dispersed in SiO₂;
wherein the hydrogen storage alloy is selected from a group consisting of LaNi_{4.3}Al_{0.7}, LaNi_{4.5}Mg_{0.5}, LaNi_{4.5}Fe_{0.5}, LaNi_{4.5}Mn_{0.5}, LaNi_{4.5}CO_{0.5}, and combinations thereof.

9. A method for preparing a hydrogen storage material comprising:
preparing particles of a hydrogen storage alloy,
wherein the alloy particles have a formula of LNi₅₋ₓMₓ, wherein L is at least one element selected from lanthanoids, and M is at least one element selected from Group II, Group III, Group VIIB, and Group VIIIB of the element periodic table, and wherein x is in a range of from 0 to about 4.5;
preparing a matrix forming material;
mixing the alloy particles and the material; and
solidifying the mixture to form a matrix with the particles dispersed therein.

10. The method of claim 9, wherein the mixing is at a temperature of between about 60 to about 100° C.

11. The method of claim 9, wherein the matrix forming material comprises a solvent.

12. The method of claim 11, wherein the solidifying step comprising removing the solvent.

13. The method of claim 12, wherein the method for removing the solvent comprises use of a vacuum of between about 0.1 to about 1 Pa for between about 5 and about 10 hours.

14. The method of claim 12, wherein the mixture is allowed to stand for about 6 to about 15 days at a temperature of between about 20 to about 40° C. before removing the solvent.

15. The method of claim 9, wherein the step of preparing the hydrogen storage alloy particles comprises:
melting a raw material comprising L, Ni, and M to form an alloy; and
crushing the alloy into particles.

16. The method of claim 15, further comprising a step of:
absorbing and desorbing hydrogen at least one time.

17. The method of claim 9, wherein the matrix forming material comprises tetrapropyl orthosilicate.

18. The method of claim 17, wherein the weight ratio of the hydrogen storage alloy particles to tetrapropyl orthosilicate is between about 1:1 to about 1:10.

19. The method of claim 17, wherein the step of preparing a matrix forming material comprises:
mixing propyl alcohol and tetrapropyl orthosilicate at a volume ratio of about 1:1.2 to about 1:2.5 to form a first solution;
mixing propyl alcohol and water at a volume ratio of from about 1:0.3 to about 1:0.8 to form a second solution;
adjusting pH of the second solution to a range of between about 1 to about 3;
mixing the first solution and the second solution at a volume ratio of from about 1:1 to about 1:2 to form a third solution; and
stirring the third solution at a stirring speed of between about 50 to about 150 r/min for about 2 to about 8 hours to provide the a matrix forming material.

20. The method of claim 19, wherein the mixing of the first solution and the second solution is at a temperature of from about 60 to about 90° C.
